(19) United States
(12) Patent Application Publication
(10) Pub. No.: US 2016/0344197 A1
(43) Pub. Date: Nov. 24, 2016

(54) Pulsed Energy Battery Charger

(71) Applicant: Franklin J. Hartley, Beaverton, OR (US)

(72) Inventor: Franklin J. Hartley, Beaverton, OR (US)

(21) Appl. No.: 14/719,210

(22) Filed: May 21, 2015

(51) Int. Cl. H02J 7/00

(52) U.S. Cl. CPC H02J 7/007; H02J 7/0052

(57) ABSTRACT

A battery charging process for lithium-ion or other types of rechargeable batteries that utilizes pulsed energy. Charging circuitry generates a wave train of periodic energy pulses whose frequency, wave shape, and amplitude are based on battery type and formulation characteristics. Charging circuitry generates, rectifies, amplifies, and isolates the pulse wave train before applying them to the battery resulting in faster charging times and fewer detrimental effects on the subject batteries.

### BACKGROUND OF THE INVENTION

Conventional forms of charging lithium ion batteries, such as constant current or constant voltage methods, require extensive times to complete the charging of a battery under safe charging conditions. These lengthy charging times limit the practicality and usefulness of the devices the battery is powering.

Conventional rapid charging methods for lithium ion batteries use high current techniques that expose the battery to potentially dangerous catastrophic failure and greatly reduce the life of a battery or set of batteries. Battery failure poses both a danger to the device and the device user/operator as well as increasing the overall operating cost of the battery powered device. As a result, it would be desirable to have a battery charging method that can safely charge batteries faster than conventional methods while at the same time lowering or eliminating charging hazards and detrimental effects to the battery, thus providing the benefits of faster charging, improved battery life, and lower operational costs.

### BRIEF SUMMARY OF THE INVENTION

Disclosed herein is a method for charging lithium ion or other rechargeable batteries that results in faster charging times while reducing charging hazards and detrimental effects upon the battery. The method is generally composed of applying pulsed energy through appropriate circuitry to the rechargeable battery at suitable frequency and amplitudes.

Conventional methods for battery charging are slow and standard rapid charging methods pose risks to both the battery and user. Pulsed energy charging allows for faster than normal charging without the inherent hazards of conventional high current rapid charging.

This battery charging method could be used as either a stand-alone battery charger for charging removable batteries or as part of an assembly circuit within a larger system for charging permanently installed batteries.

### BRIEF DESCRIPTION OF THE DRAWINGS

FIG. 1 is a flow diagram of the pulsed energy battery charger process with its major functional areas and process flow.

FIG. 2 is a semi-flow diagram schematic of the pulsed energy battery charger process with key components and functional blocks identified and the process effects on sample waveforms displayed.

### DETAILED DESCRIPTION OF THE INVENTION

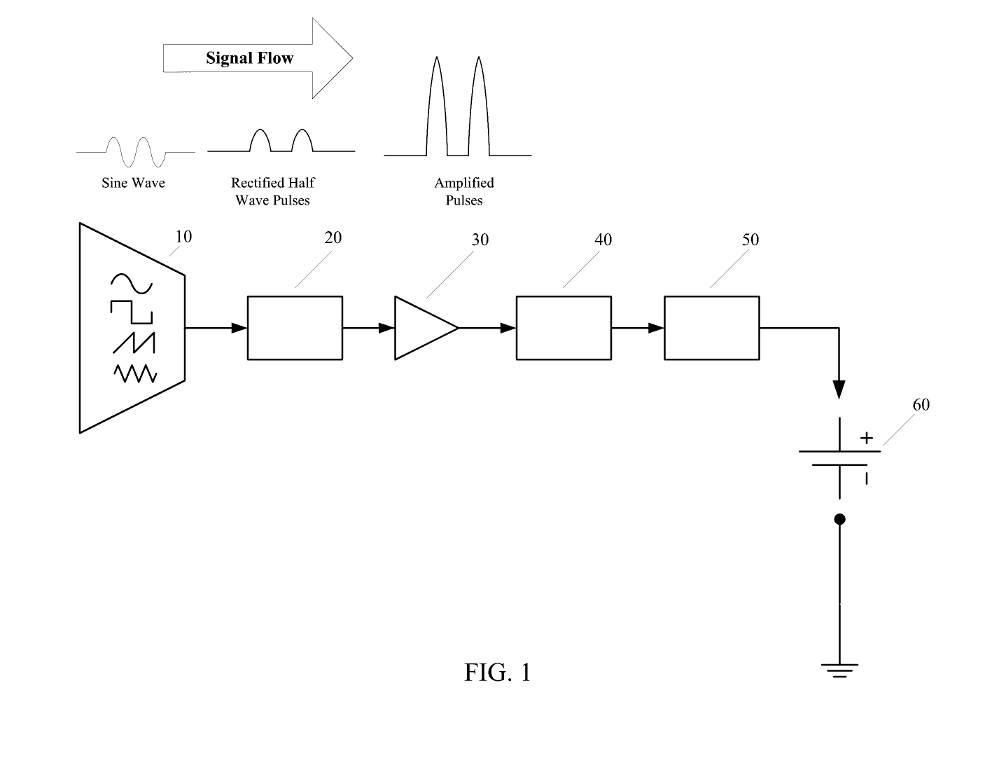

Referring to FIG. 1, this is a preferred embodiment of a schematic flow diagram of the process with Function Generator Circuit 10 creating a periodic signal such as a sine wave. The periodic signal is then rectified by Rectifier Circuit 20, converting the full wave signal into a half wave signal. The half-wave signal is then amplified to the appropriate useful level by Amplifier Circuit 30. The amplified half-wave signal from Amplifier Circuit 30 then progresses through a protective Isolation Circuit 40 which prevents the back flow of energy from the charging battery back into the charging circuit. The amplified signal will then progress through Current Limiting Circuit 50 to safely limit charging current into the subject Rechargeable Battery 60.

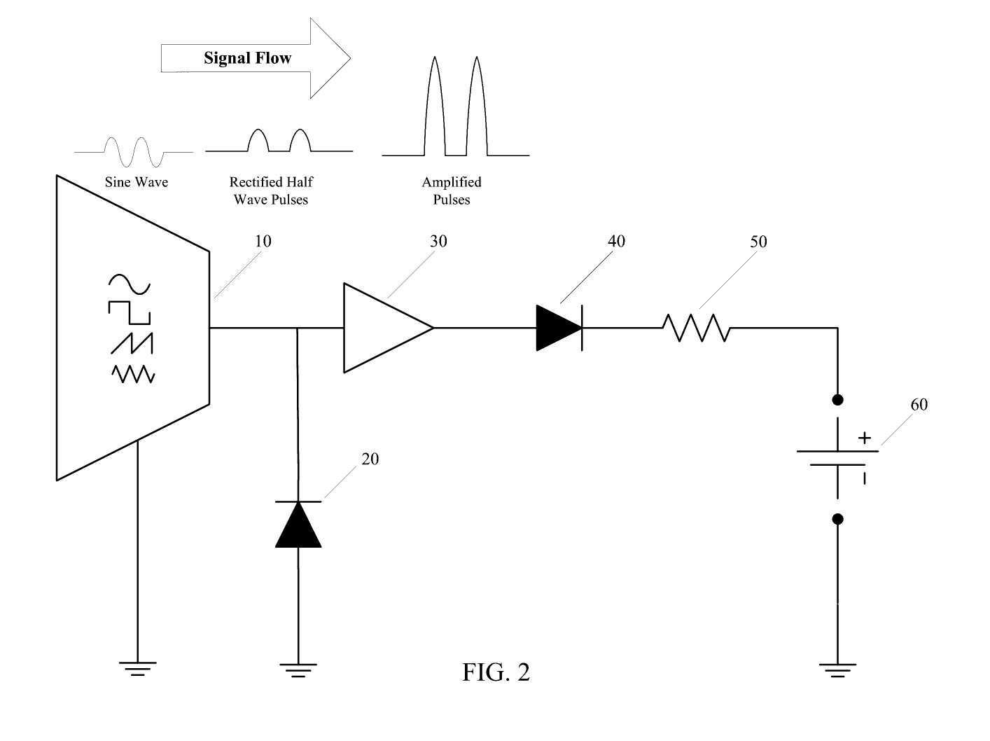

Referring to FIG. 2, this is a preferred embodiment of the battery charger semi-schematic flow diagram. Function Generator Circuit (FGC) 10 supplying a periodic signal may be of a type of microprocessor based integrated circuit (IC) or specialty Function Generator IC. FGC 10 could also consist of discrete electronic components making up an oscillator circuit or it could be a simple step down transformer that reduces the sine wave provided by standard AC power mains power if a 60 Hz sine wave is the desired periodic waveform. Any of these means could be used to generate the periodic signal based upon the desired application of the charger.

The periodic signal produced by FGC 10 may have a waveform shape of sine wave, square wave, triangle wave, ramp wave, or irregular wave shape. Wave form shape may be selected based on rechargeable battery formulation or other desirable charger requirements.

Rectification of the full-wave periodic signal into a half-wave energy pulse signal is performed by Rectification Circuit 20. Rectification Circuit 20 may be performed by either a single discrete diode (element 20) of suitable sizing (as shown), or using a full wave bridge rectifier consisting of either an integrated full-wave rectifier IC, or a full-wave bridge circuit of discrete diodes.

The half-wave pulse signal from Rectifier Circuit 20 becomes amplified to a useable level by Amplifier Circuit 30. Amplifier Circuit 30 may consist of discrete components, an integrated circuit op-amp, or an integrated power module depending upon the required output levels for the battery charger.

Protective Isolation Circuit 40 prevents energy from flowing back from the battery or batteries under charge back into the earlier charging circuit protecting circuit elements 10, 20, and 30. The Protective Isolation Circuit 40 circuit component would most commonly be provided as a diode of sufficient current and voltage capacity but could be rendered with other active discrete or integrated parts. Protective Isolation Circuit 40 may either precede (as shown) or follow the Current Limiting Circuit 50.

Current Limiting Circuit 50 prevents battery charging current from exceeding safe manufactures limits. Current Limiting Circuit 50 can consist of a simple power resistor of sufficient capacity or be rendered with active discrete or integrated parts. Charging current then flows into the subject Rechargeable Battery(s) 60. During the charging process the Rechargeable Battery(s) 60 are electrically connected and mechanically held in place by a suitable battery fixture allowing for either temporary, removable battery charging or a permanent installation battery charging assembly.

1: a method for charging rechargeable batteries, said method comprising:
the application of regulated periodic energy pulses to one or more batteries under charge.

2: the charging method of claim 1 further comprising oscillator circuitry for the means of generating said periodic energy pulses.

3: the charging method of claim 1 further comprising rectification circuitry for the means of rectifying said periodic energy pulses.

4: the charging method of claim 1 further comprising amplifier circuitry for the means of amplifying said periodic energy pulses.

5: the charging method of claim 1 further comprising protective isolating circuitry for the means of providing protective isolation from the battery under charge.

6: the charging method of claim 1 further comprising current regulating circuitry for the means of regulating charging current into the battery under charge.
